(19) United States
(12) Patent Application Publication
(10) Pub. No.: US 2015/0120384 A1
(43) Pub. Date: Apr. 30, 2015

(54) SYSTEMS AND METHODS FOR CREDIT CARD DEMAND FORECASTING USING REGIONAL PURCHASE BEHAVIOR

(71) Applicant: MasterCard International Incorporated, Purchase, NY (US)

(72) Inventors: Jean-Pierre Gerard, Croton-On-Hudson, NY (US); Po Hu, Norwalk, CT (US); Rohit Chauhan, Somers, NY (US); Tong Zhang, Greenwich, CT (US)

(73) Assignee: MasterCard International Incorporated, Purchase, NY (US)

(21) Appl. No.: 14/063,846

(22) Filed: Oct. 25, 2013

(51) Int. Cl. G06Q 30/02

(52) U.S. Cl. CPC G06Q 30/0202; G06Q 30/0205
USPC 705/7.31

(57) ABSTRACT

A computer-implemented method and system for forecasting a demand for a credit-based payment card implemented using a demand forecasting computer device coupled to a memory device. The method includes retrieving financial transaction data for a plurality of payment card cardholders acquired by the demand forecasting computer device and stored in the memory device, determining variables in the financial transaction data that predict the demand for a credit-based payment card using an independent variables generation engine, integrating the retrieved financial transaction data, economic data received from sources external to the demand forecasting computer device, and data relating to new payment card cardholders based on the determined variables, generating a prediction of the demand for credit in a selectable geographic area using a cross-sectional model of the integrated data and the determined variables, and outputting the prediction.

### BACKGROUND

This disclosure relates generally to processing data and, more particularly, to computer systems and computer-based methods for predicting a demand for credit by consumers in selectable geographic areas using data internal to a demand forecasting computer device and data received from external sources.

Many businesses market their services to consumers using methods that can be very expensive. Reaching consumers that can not use a merchant's services and not reaching those consumers that are in need of the merchant's services are costly to the merchant. Direct marketing is used for specific locations such as a consumer's home, and Internet advertising may reach a large number of consumers, however, localizing the consumer to a specific area may be difficult. Moreover, correlating a consumer location to a demand for services in that location has been difficult. For example, methods for forecasting credit demand for large populations have been used over the years. However, none of these methods have been able to forecast credit demand for consumers by location of the consumers.

It would be desirable to provide a system and/or method for understanding the credit demand in certain geographic areas, increasing a response rate of credit issuers by targeting the high demand areas, allocating resources of a credit issuer more efficiently with seasonal credit demand information, and focusing marketing efforts of an issuer to optimize market promotions.

### BRIEF DESCRIPTION OF THE DISCLOSURE

In one embodiment, a computer-implemented method for forecasting a demand for a credit-based payment card implemented using a demand forecasting computer device coupled to a memory device. The method includes retrieving financial transaction data for a plurality of payment card cardholders acquired by the demand forecasting computer device and stored in the memory device, determining variables in the financial transaction data that predict the demand for a credit-based payment card using an independent variables generation engine, integrating the retrieved financial transaction data, economic data received from sources external to the demand forecasting computer device, and data relating to new payment card cardholders based on the determined variables, generating a prediction of the demand for credit in a selectable geographic area using a cross-sectional model of the integrated data and the determined variables, and outputting the prediction.

In another embodiment, a computer system for processing data, the computer system comprising a memory device and a processor in communication with the memory device, the processor programmed to retrieve financial transaction data for a plurality of payment card cardholders acquired by the demand forecasting computer device and stored in the memory device, determine variables in the financial transaction data that predict the demand for a credit-based payment card using an independent variables generation engine, integrate the retrieved financial transaction data, economic data received from sources external to the demand forecasting computer device, and data relating to new payment card cardholders based on the determined variables, generate a prediction of the demand for credit in a selectable geographic area using a cross-sectional model of the integrated data and the determined variables, and output the prediction.

In yet another embodiment, one or more non-transitory computer-readable storage media having computer-executable instructions embodied thereon that when executed by at least one processor, the computer-executable instructions cause the processor to retrieve financial transaction data for a plurality of payment card cardholders acquired by the demand forecasting computer device and stored in the memory device, determine variables in the financial transaction data that predict the demand for a credit-based payment card using an independent variables generation engine, integrate the retrieved financial transaction data, economic data received from sources external to the demand forecasting computer device, and data relating to new payment card cardholders based on the determined variables, generate a prediction of the demand for credit in a selectable geographic area using a cross-sectional model of the integrated data and the determined variables, and output the prediction.

### BRIEF DESCRIPTION OF THE DRAWINGS

FIGS. 1-8 show example embodiments of the methods and systems described herein.

FIG. 1 is a schematic diagram illustrating an example multi-party transaction card system for enabling ordinary payment-by-card transactions in which merchants and card issuers do not need to have a one-to-one special relationship.

FIG. 2 is a simplified block diagram of an example processing system including a plurality of computer devices including a demand forecasting device in accordance with one embodiment of the present disclosure.

FIG. 3 is an expanded block diagram of an example embodiment of a server architecture of the processing system including other computer devices in accordance with one embodiment of the present disclosure.

FIG. 4 illustrates an example configuration of a user system operated by a user, such as the client device shown in FIGS. 2 and 3.

FIG. 5 illustrates an example configuration of a server system such as the server system shown in FIGS. 2 and 3.

FIG. 6 is a data flow diagram illustrating a plurality of sources of data used by a demand forecasting device as shown in FIGS. 2 and 3 for forecasting a demand for a credit-based payment card.

FIG. 7 is a data flow diagram of a credit card demand forecast process implemented using the demand forecasting device shown in FIGS. 2 and 3.

FIG. 8 is a flow diagram of a method for forecasting a demand for a credit-based payment card implemented in the demand forecasting device shown in FIGS. 2 and 3.

### DETAILED DESCRIPTION OF THE DISCLOSURE

Embodiments of the methods and systems described herein relate to a demand forecasting computer device and method of predicting a demand for new credit. The demand can be predicted in a selectable geographic area using internally stored transaction data from users of payment cards. Economic, marketing, employment data, interest rate information and other external data is imported from sources external to the demand forecasting computer device. These external sources of information are also used to predict the demand for credit. The transaction data is used to determine variables in the data that tend to predict the demand for credit. The additional economic, marketing, and other data are used with the variables in a model engine to generate a demand indicator or prediction of a demand for credit.

The variables created by an independent variables generation engine are stored in a separate data source. The separation of input data and output variables into two physical storages provides great flexibility and scalability in adding new functions or scoring programs.

For each geographic area, a credit demand index is calculated, for example, but not limited to, by dividing total number of active cardholders by the total number of eligible card applicants group, which fall in certain demographic groups.

In one embodiment, the independent variables generation engine includes a time series analyzer, such as, an Autoregressive Integrated Moving Average (ARIMA) Model, which may be fitted to time series data to predict future points in the series. The time series data may exclude exogenous covariates. The model generally includes parameters p, d, and q, which are non-negative integers that refer to the order of the autoregressive, integrated, and moving average parts of the model respectively. An interface permits control of model parameters, such as, but not limited to, a forecast horizon, AMRA p, q, variables, geo level, and exogenous factors. The time series analyzer may analyze a sequence of data points, measured typically at successive points in time spaced at known time intervals to predict future values based on previously observed values. Using the time series analyzer, a change in credit demand in various geo-locations can be determined

An estimate of the cardholder's zip code of residency can be determined using a zip code model. An estimate of the total number of active cardholders grouped by zip code can then be determined using, for example, for each current cardholder, historical transaction location information tracking a predetermined or selectable time period since a first seen date or origination date of the card usage. A time series of the credit demand index for each zip code is created, so that, by applying the ARIMA models, the future credit demand based on the historical seasonality can be predicted.

In at least one embodiment, satisfactory results are achieved with only transaction data and a limited number of macro-economic factors. A Preliminary Cross-Sectional Ranking Model, which uses only (i) transaction data, and (ii) macro-economic factors to identify the demographic characteristics and purchase behaviors that predict which ZIP codes will have the highest rate of new cards the following month. The inclusion of issuer-provided campaign history and additional macro-economic variables provides additional information, which the model can use to improve the forecast accuracy.

The methods and systems described herein may be implemented using computer programming or engineering techniques including computer software, firmware, hardware or any combination or subset thereof, wherein the technical effect may include at least one of: (a) using the forecast computer device to retrieve financial transaction data for a plurality of payment card cardholders stored in the memory device, (b) determining variables in the financial transaction data that predict the demand for a credit-based payment card using an independent variables generation engine, (c) integrating the retrieved financial transaction data, economic data received from sources external to the demand forecasting computer device, and data relating to new payment card cardholders based on the determined variables, (d) generating a prediction of the demand for credit in a selectable geographic area using a cross-sectional model of the integrated data and the determined variables, and (e) outputting the prediction.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers. Each type of transactions card can be used as a method of payment for performing a transaction.

In one embodiment, a computer program is provided, and the program is embodied on a computer readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

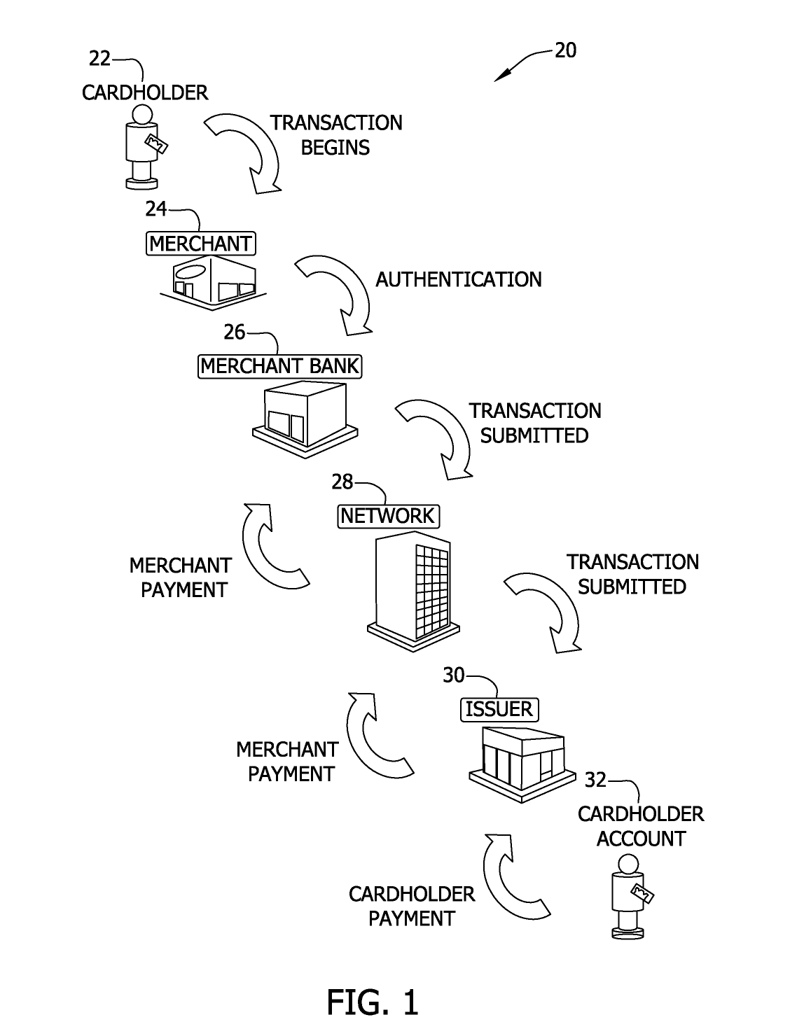

FIG. 1 is a schematic diagram illustrating an example multi-party transaction card industry system 20 for enabling ordinary payment-by-card transactions in which merchants 24 and card issuers 30 do not need to have a one-to-one special relationship. Embodiments described herein may relate to a transaction card system hosted by a demand forecasting computer device, such as a credit card payment system using the MasterCard® interchange network or a third party service provider. The MasterCard® interchange network is a four-party payment card interchange network that includes a plurality of special purpose processors and data structures stored in one or more memory devices communicatively coupled to the processors, and a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, New York).

In a typical transaction card system, a financial institution called the “issuer” issues a transaction card, such as a credit card, to a consumer or cardholder 22, who uses the transaction card to tender payment for a purchase from a merchant 24. To accept payment with the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card, merchant 24 requests authorization from a merchant bank 26 for the amount of the purchase. The request may be performed over the telephone, but is usually performed through the use of a point-of-sale terminal, which reads cardholder's 22 account information from a magnetic stripe, a chip, or embossed characters on the transaction card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using a demand forecasting computer device, such as, interchange network 28 or the service provider, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

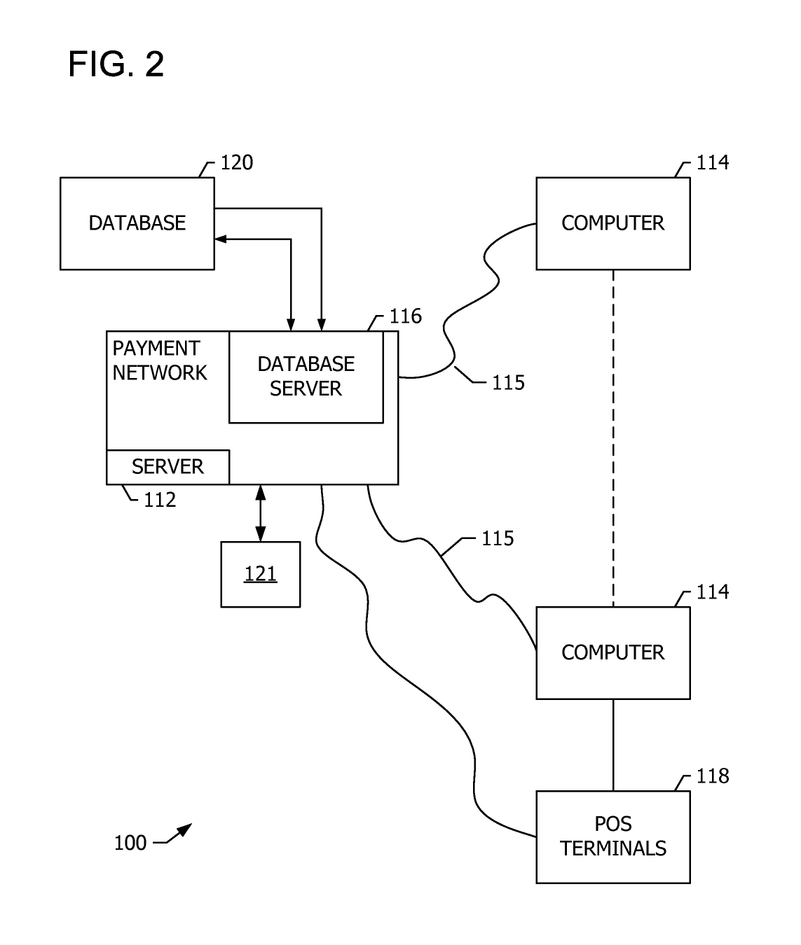

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal This may include bundling of approved transactions daily for standard retail purchases. If cardholder 22 cancels a transaction before it is captured, a “void” is generated. If cardholder 22 returns goods after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the example embodiment, when cardholder 22 purchases travel, such as airfare, a hotel stay, and/or a rental car, at least partial itinerary information is transmitted during the clearance process as transaction data. When interchange network 28 receives the itinerary information, interchange network 28 routes the itinerary information to database 120.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

FIG. 2 is a simplified block diagram of an example processing system 100 including a plurality of computer devices in accordance with one embodiment of the present disclosure. In the example embodiment, processing system 100 may be used for performing payment-by-card transactions forecasting credit demand in a geographic area. For example, processing system 100 may include a credit card demand forecasting component 606 that uses an algorithm combining geo-level purchase behaviors, macro-economic factors and other sources to predict the demand for new credit card in a selectable geographic area such as, but, not limited to a postal code, a county, a city or another geo-grouping. In another embodiment, demand forecasting component 121 may be a separate computing device located at a third party service provider who provides credit forecasting as described herein as a service for the payment processing network.

More specifically, in the example embodiment, processing system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment.

Processing system 100 also includes point-of-sale (POS) terminals 118, which may be connected to client systems 114 and may be connected to server system 112. POS terminals 118 are interconnected to the Internet through many interfaces including a network, such as a local area network (LAN) or a wide area network (WAN), dial-in-connections, cable modems, wireless modems, and special high-speed ISDN lines. POS terminals 118 could be any device capable of interconnecting to the Internet and including an input device capable of reading information from a consumer's financial transaction card.

A database server 116 is connected to database 120, which contains information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

Database 120 may include a single database having separated sections or partitions or may include multiple databases, each being separate from each other. Database 120 may store transaction data generated as part of sales activities conducted over the processing network including data relating to merchants, account holders or customers, issuers, acquirers, purchases made. Database 120 may also store account data including at least one of a cardholder name, a cardholder address, an account number, and other account identifier. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data. Database 120 may store financial transaction data for a plurality of payment card cardholders, variables in the financial transaction data that predict the demand for a credit, economic data received from sources external to the demand forecasting computer device, and data relating to new payment card cardholders based on the variables, a cross-sectional model, economic data for a geographic area for forecasting the demand for credit in that geographic region, employment data, business activity, retail activity, banking activity, and interest rates in the geographic areas.

Demand forecasting component 121 may be connected to server system 112 for communicating credit demand forecasting information. Processing of the credit demand forecasting information may be processed by server system 112 or may be processed by demand forecasting component 121, or may be processed by both server system 112 and demand forecasting component 121.

In the example embodiment, one of client systems 114 may be associated with acquirer bank 26 (shown in FIG. 1) while another one of client systems 114 may be associated with issuer bank 30 (shown in FIG. 1). POS terminal 118 may be associated with a participating merchant 24 (shown in FIG. 1) or may be a computer system and/or mobile system used by a cardholder making an on-line purchase or payment. Server system 112 may be associated with interchange network 28. In the example embodiment, server system 112 is associated with a network interchange, such as interchange network 28, and may be referred to as an interchange computer system. Server system 112 may be used for processing transaction data. In addition, client systems 114 and/or POS 118 may include a computer system associated with at least one of an online bank, a bill payment outsourcer, an acquirer bank, an acquirer processor, an issuer bank associated with a transaction card, an issuer processor, a remote payment system, a biller, and/or a credit forecasting system. The credit forecasting system may be associated with interchange network 28 or with an outside third party in a contractual relationship with interchange network 28. Accordingly, each party involved in processing transaction data are associated with a computer system shown in processing system 100 such that the parties can communicate with one another as described herein.

Using the interchange network, the computers of the merchant bank or the merchant processor will communicate with the computers of the issuer bank to determine whether the consumer's account is in good standing and whether the purchase is covered by the consumer's available credit line. Based on these determinations, the request for authorization will be declined or accepted. If the request is accepted, an authorization code is issued to the merchant.

When a request for authorization is accepted, the available credit line of consumer's account is decreased. Normally, a charge is not posted immediately to a consumer's account because bankcard associations, such as MasterCard International Incorporated®, have promulgated rules that do not allow a merchant to charge, or “capture,” a transaction until goods are shipped or services are delivered. When a merchant ships or delivers the goods or services, the merchant captures the transaction by, for example, appropriate data entry procedures on the point-of-sale terminal If a consumer cancels a transaction before it is captured, a “void” is generated. If a consumer returns goods after the transaction has been captured, a “credit” is generated.

For debit card transactions, when a request for a PIN authorization is approved by the issuer, the consumer's account is decreased. Normally, a charge is posted immediately to a consumer's account. The bankcard association then transmits the approval to the acquiring processor for distribution of goods/services, or information or cash in the case of an ATM.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which is settled as a group.

The financial transaction cards or payment cards discussed herein may include credit cards, debit cards, a charge card, a membership card, a promotional card, prepaid cards, and gift cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), key fobs, or other devices, etc.

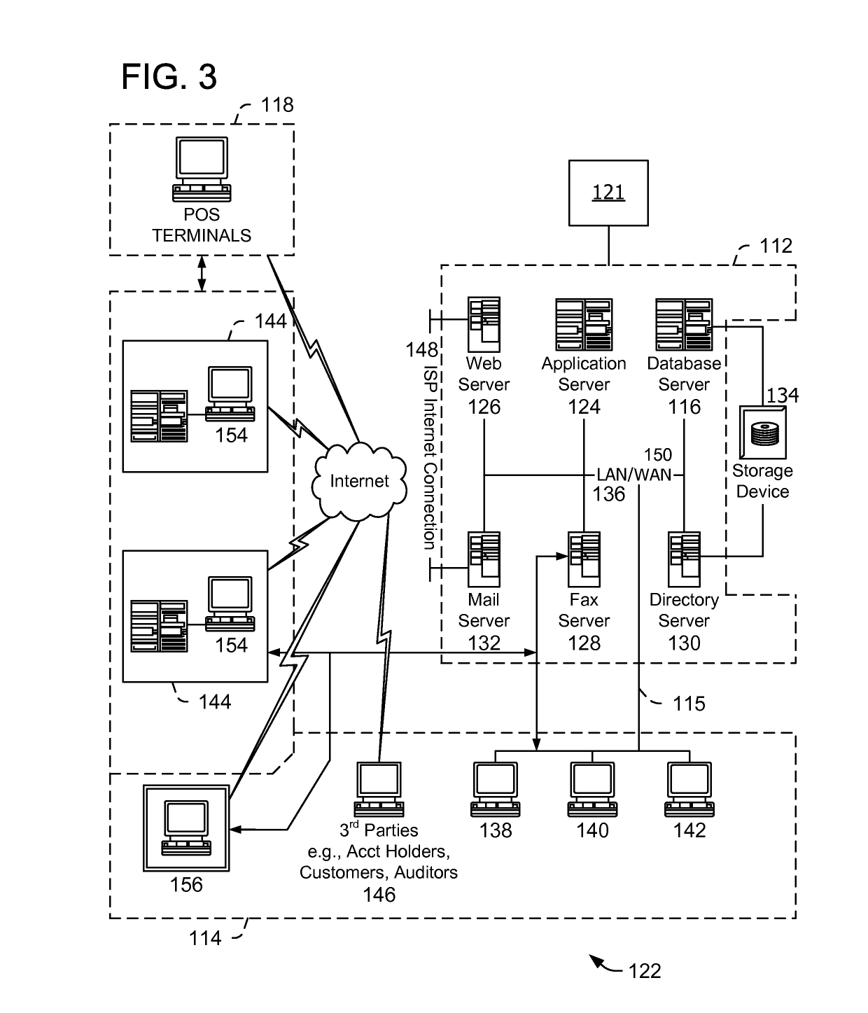

FIG. 3 is an expanded block diagram of an example embodiment of a server architecture of a processing system 122 including other computer devices such as, demand forecasting component 121. Components in system 122, identical to components of processing system 100 (shown in FIG. 2), are identified in FIG. 3 using the same reference numerals as used in FIG. 2. System 122 includes server system 112, client systems 114, and POS terminals 118. Server system 112 further includes database server 116, a transaction server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

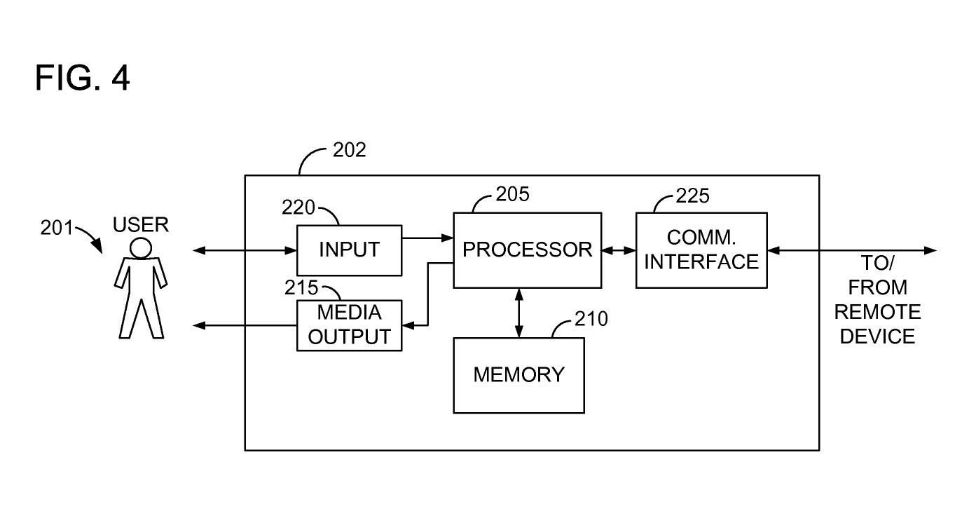

FIG. 4 illustrates an example configuration of a user system 202 operated by a user 201, such as cardholder 22 (shown in FIG. 1). User system 202 may include, but is not limited to, client systems 114, 138, 140, and 142, POS terminal 118, workstation 154, and manager workstation 156. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as server system 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

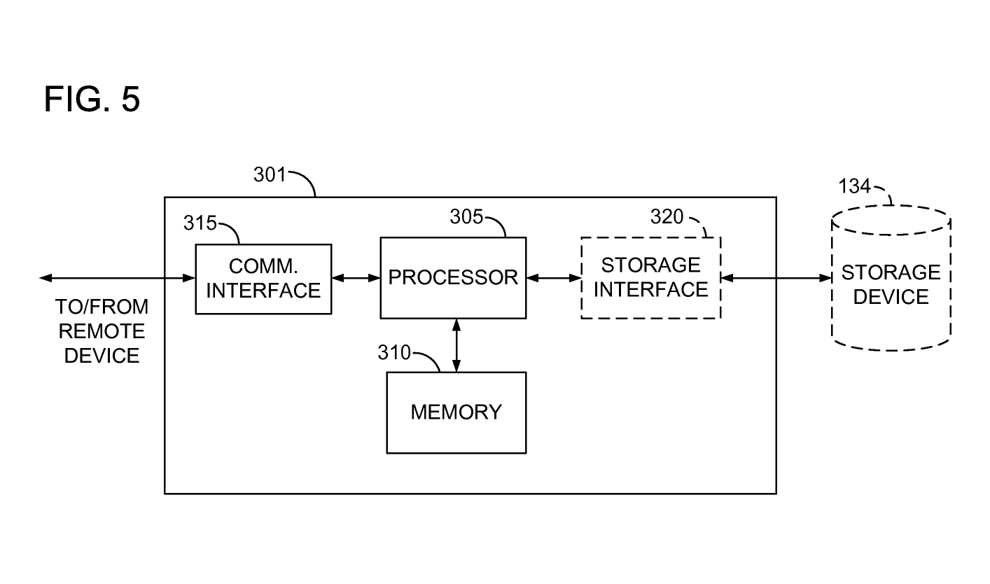

FIG. 5 illustrates an example configuration of a server system 301 such as server system 112 (shown in FIGS. 2 and 3). Server system 301 may include, but is not limited to, database server 116, transaction server 124, web server 126, fax server 128, directory server 130, and mail server 132.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

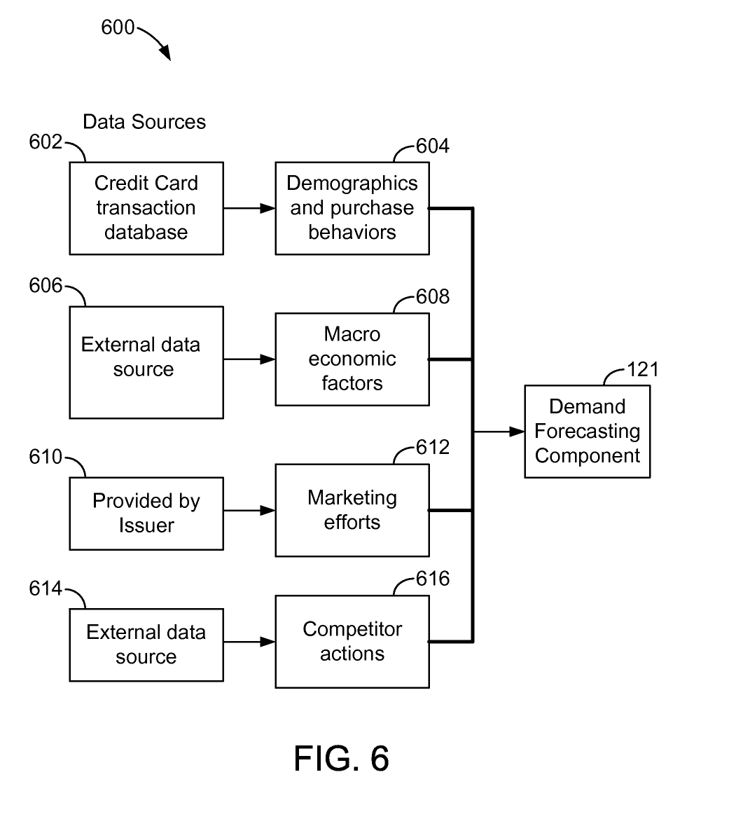

FIG. 6 is a data flow diagram 600 illustrating a plurality of sources of data used by processing system 100 for forecasting a demand for a credit-based payment card. More specifically, processing system 100 may receive data from internal and external sources and channel at least portions of the data to demand forecasting component 121 for forecasting the demand for credit as described hereon. Alternatively, the data may be received directly by demand forecasting component 121. In the example embodiment, a financial transaction database 602, internal to the demand forecasting computer device is used to generate demographics and purchase behavior data 604 based on a geographic area that is predetermined or selectable by a user through an interface operable between the user and processing system 100. Sources of macro-economic data 606 are used to generate macro-economic factors 608 that are considered by the internal models using the methods described herein.

Marketing data 610 provided by issuers 30 is used to determine marketing efforts 612 instituted by the issuers 30. Competitor intelligence source 614 is used to generate competitor action data 616. External data 606, 610, and 614 may be provided by external partners, such as, but, not limited to issuers 30, and/or commercial data aggregators that are subscribed to various information websites or that scrape news websites, competitor websites, government databases, and/or other external data sources. A key source of data is the internal data owned exclusively by the demand forecasting computer device. This financial transaction data is received in normal course of demand forecasting computer device's business. Each of purchase behavior data 604, macro-economic factors 608, marketing efforts 612, and competitor action data 616 may be further processed prior to the respective data being transmitted to demand forecasting component 121. Alternatively, components 604, 608, 612, and 616 may transmit raw data to demand forecasting component 121.

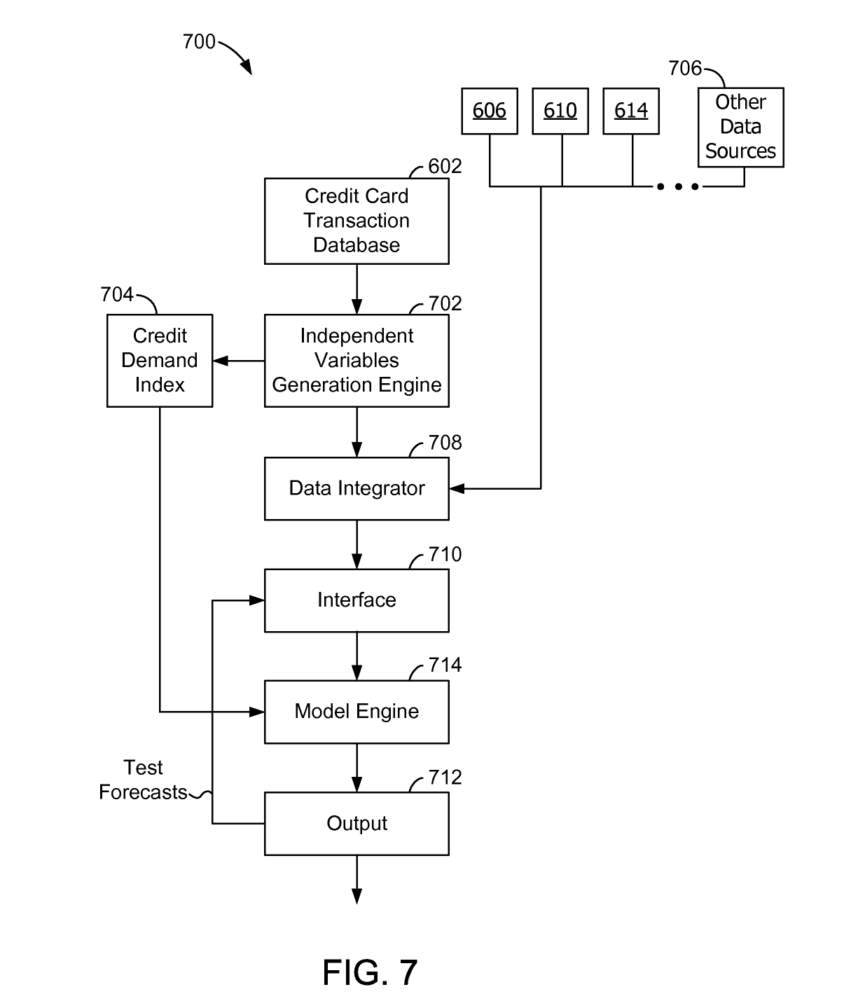

FIG. 7 is a data flow diagram of a credit card demand forecast process 700 implemented by demand forecasting component 121 in communication with processing system 100. In the example embodiment, internal credit card database 602 provides demographics and purchase behavior information to an independent variables generation engine 702, which uses the transaction data to create a target variable. The target variable is the outcome variable, or the variable being predicted. In the example embodiment, the target variables are the new payment cards by selected geographic area, which may be expressed as a ratio of active cardholders to eligible cardholders in each geographic area. The ratio can indicate a degree of penetration of the payment card being issued to households in the population.

Moreover, variables generation engine 702 creates a credit demand index 704, which, in various embodiments, includes a time series of the outcome of the predicted variable, for example, the ratio of active cardholders to eligible cardholders in each of a plurality of geographic areas. The ratio is determined for each geographic area for each of a series of time periods. Generally the time periods are consecutive and are of a selectable duration.

External sources of data provide data 606, 610, 614, and other external data 706 from any other external sources of data to a data integrator 708. Data integrator 708 organizes and formats data 606, 610, 614, and 706 for processing and also ranks and weights the data based at least in part on the generated variables received from engine 702.

An interface 710 receives the integrated data from data integrator 708 and previous predictions or forecasts from an output component 712. A model engine 714 receives an output of credit demand index 704 and processed data output from interface 710 to predict a demand for credit and/or a demand for credit cards in one or more selected geographic areas. Output component 712 tests the results and outputs results including parameters that exceed a threshold range. The results may also be tested for convergence to a value. The final results may be output and/or intermediate results can be transmitted back to interface 710 for further processing.

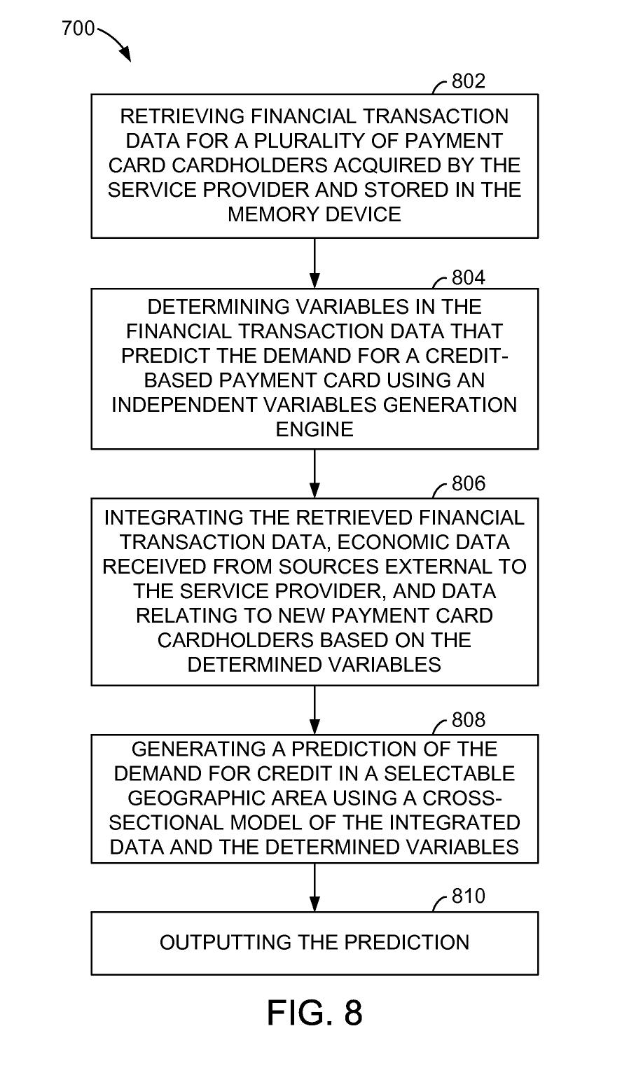

FIG. 8 is a flow diagram of a method 800 for forecasting a demand for a credit-based payment card in accordance with an example embodiment of the present disclosure. Method 800 is implemented using demand forecasting computer device. In the example embodiment, method 800 includes retrieving 802 financial transaction data for a plurality of payment card cardholders acquired by the demand forecasting computer device and stored in the memory device, determining 804 variables in the financial transaction data that predict the demand for a credit-based payment card using an independent variables generation engine, integrating 806 the retrieved financial transaction data, economic data received from sources external to the demand forecasting computer device, and data relating to new payment card cardholders based on the determined variables, generating 808 a demand indicator or prediction of the demand for credit in a selectable geographic area using a cross-sectional model of the integrated data and the determined variables, and outputting 810 the prediction. In various embodiments, the prediction may be a relative value indicating an amount of under or over service of credit in a particular geo-location or over a period of time. For example, the prediction may compare various geo-locations for a level of credit demand in those regions. From this, marketing credit in one location may be able to be determined over another location. Likewise, it may be determined that over time the demand for new credit is increasing because a number of cardholders compared to eligible cardholders is changing. The prediction may take the form of a percentage indicating actual cardholders compared to eligible card holders in a geo-location or the prediction may take the form of a time-based trend.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processors 205 and/or 305, including RAM memory, ROM memory, EPROM memory, EEPROM memory, and non-volatile RAM (NVRAM) memory. The above memory types are examples only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof, wherein the technical effect is identifying a consumer account, creating a model data file associated with a payment card, and configuring one or more physical components of the payment card. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. In other words, the machine-readable medium and the computer-readable medium described herein are non-transitory. The term “machine-readable signal” refers to any signal used to provide machine instructions and/or data to a programmable processor.

The above-described embodiments of a method and system of using financial transaction data models and macro-economic models for a geographic area to forecast a demand for a credit-based payment card provides a cost-effective and reliable means of predicting the demand for new credit card in each geographic area using variables linked to purchase behaviors. More specifically, the methods and systems described herein facilitate integrating additional macro-economic variables and historical marketing activity into models can be to improve the prediction. In addition, the above-described methods and systems facilitate using issuer-provided campaigns history to provide an accurate forecast of response rates for new card promotions at any level of geographic resolution.

As a result, the methods and systems described herein facilitate understanding the credit demand in certain geographic areas, increasing a response rate of credit issuers by targeting the high demand areas, allocating resources of a credit issuer more efficiently with seasonal credit demand information, and focusing marketing efforts of an issuer to optimize market promotions in a cost-effective and reliable manner.

This written description uses examples to disclose the disclosure, including the best mode, and also to enable any person skilled in the art to practice the disclosure, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for forecasting a demand for a credit-based payment card, the method implemented using a demand forecasting computer device coupled to a memory device, the method comprising:
retrieving financial transaction data for a plurality of payment card cardholders acquired by the demand forecasting computer device and stored in the memory device;
determining variables in the financial transaction data that predict the demand for a credit-based payment card using an independent variables generation engine;
integrating the retrieved financial transaction data, economic data received from sources external to the demand forecasting computer device, and data relating to new payment card cardholders based on the determined variables;
generating a prediction of the demand for credit in a selectable geographic area using a cross-sectional model of the integrated data and the determined variables; and
outputting the prediction.

2. The computer-implemented method of claim 1, further comprising storing in the memory device, financial transaction data for a plurality of payment card cardholders associated with the demand forecasting computer device.

3. The computer-implemented method of claim 1, further comprising receiving a geographic area for forecasting the demand for a credit-based payment card in that geographic region.

4. The computer-implemented method of claim 1, further comprising determining new payment card cardholders using the stored transaction data by determining a time when a payment card associated with a cardholder is first used.

5. The computer-implemented method of claim 1, further comprising estimating a geographic area of residence of the plurality of payment card cardholders using the financial transaction data.

6. The computer-implemented method of claim 1, wherein determining variables comprises correlating the transaction data and the economic data.

7. The computer-implemented method of claim 1, wherein determining variables comprises correlating transaction data with an industry associated with at least one of a merchant and a purchased item or service.

8. The computer-implemented method of claim 1, wherein storing at the central store comprises storing at the central store at least one of employment data, business activity, retail activity, banking activity, and interest rates in the one or more geographic areas.

9. The computer-implemented method of claim 1, further comprising receiving marketing data that relates to an offer of credit to residents in the one or more geographic areas.

10. The computer-implemented method of claim 1, further comprising determining if a payment card cardholder of the plurality of payment card cardholder is a new payment card cardholder, the new payment card cardholder being a payment card cardholder that has first used a payment card within a recent predetermined time period based on the stored transaction data.

11. The computer-implemented method of claim 1, further comprising determining a trend of a prediction of the demand for a credit-based payment card in the received geographic area over a selectable period of time.

12. A computer system for processing data, the computer system comprising a memory device and a processor in communication with the memory device, the processor programmed to:
retrieve financial transaction data for a plurality of payment card cardholders acquired by the demand forecasting computer device and stored in the memory device;
determine variables in the financial transaction data that predict the demand for a credit-based payment card using an independent variables generation engine;
integrate the retrieved financial transaction data, economic data received from sources external to the demand forecasting computer device, and data relating to new payment card cardholders based on the determined variables;
generate a prediction of the demand for credit in a selectable geographic area using a cross-sectional model of the integrated data and the determined variables; and
output the prediction.

13. The computer system of claim 12, wherein the processor is further programmed to receive a geographic area for forecasting the demand for a credit-based payment card in that geographic region.

14. The computer system of claim 12, wherein the processor is further programmed to determine new payment card cardholders using the stored transaction data by determining a time when a payment card associated with a cardholder is first used.

15. The computer system of claim 12, wherein the processor is further programmed to estimate a geographic area of residence of the plurality of payment card cardholders using the financial transaction data.

16. One or more non-transitory computer-readable storage media having computer-executable instructions embodied thereon, wherein when executed by at least one processor, the computer-executable instructions cause the processor to:
retrieve financial transaction data for a plurality of payment card cardholders acquired by the demand forecasting computer device and stored in the memory device;
determine variables in the financial transaction data that predict the demand for a credit-based payment card using an independent variables generation engine;
integrate the retrieved financial transaction data, economic data received from sources external to the demand forecasting computer device, and data relating to new payment card cardholders based on the determined variables;
generate a prediction of the demand for credit in a selectable geographic area using a cross-sectional model of the integrated data and the determined variables; and
output the prediction.

17. The computer-readable storage media of claim 16, wherein the computer-executable instructions further cause the processor to correlate transaction data with an industry associated with at least one of a merchant and a purchased item or service.

18. The computer-readable storage media of claim 16, wherein the computer-executable instructions further cause the processor to store at the central store at least one of employment data, business activity, retail activity, banking activity, and interest rates in the one or more geographic areas.

19. The computer-readable storage media of claim 16, wherein the computer-executable instructions further cause the processor to determine if a payment card cardholder of the plurality of payment card cardholder is a new payment card cardholder, the new payment card cardholder being a payment card cardholder that has first used a payment card within a recent predetermined time period based on the stored transaction data.

20. The computer-readable storage media of claim 16, wherein the computer-executable instructions further cause the processor to determine a trend of a prediction of the demand for a credit-based payment card in the received geographic area over a selectable period of time.
